(19) United States
(12) Patent Application Publication
(10) Pub. No.: US 2013/0165826 A1
(43) Pub. Date: Jun. 27, 2013

(54) Massage Chair for a Foot Massager

(71) Applicant: Danny Jan, Changhua City (TW)

(72) Inventor: Danny Jan, Changhua City (TW)

(21) Appl. No.: 13/334,307

(22) Filed: Dec. 22, 2011

(51) Int. Cl. A61H 7/00

(52) U.S. Cl. 601/98

(57) ABSTRACT

A massage chair for a foot massager contains a base including two sliding rails parallel to each other mounted on an upper surface thereof; a frame including two grooves parallel to each other secured on a lower surface thereof to fit with the two sliding rails of the base, the frame also including two side plates disposed thereon and a resilient layer defined between top surfaces of the two side plates and separated by a plurality of flexible ropes, the resilient layer including a soft pad disposed thereon; a back support axially coupled with a back side of the frame; and at least one movable driving device defined between the base and the frame.

### BACKGROUND OF THE INVENTION

1. Field of the Invention

The present invention relates to a chair for a foot massager, and more particularly to a massage chair for a foot massager to be sat as soaking feet.

2. Description of the Prior Art

With reference to FIGS. 12 and 13, a conventional foot massager includes a base 3 connected with a chair 4 to be sit by a user, the base 3 includes a soaking slot 31 disposed on a front side thereof to feed hot water so as to soak the user's feet, massaging the feet to expand blood vessels, help blood circulation, relax muscles and improve cell metabolism, etc.

The chair 4 includes a seat 41, a frame 42, a first moving driving device 43, and a second movable driving device 44, wherein the seat 41 is locked on an upper end of a back side of the base 3, and the frame 42 is movably fixed on the seat 41, the first movable driving device 43 and the second movable driving device 44 are defined between the seat 41 and the frame 42, the frame 42 includes a support panel 45 secured thereon and connecting with a soft pad 46, wherein a height H from a top surface of the soft pad 46 to a bottom surface of the soaking slot 31 of the base 3 is designed based on ergonomic principle.

Nevertheless, when the user sits on the foot massager, only the soft pad 46 supports the user, so a resilient material of the soft pad 46 is used at a large quantity, and a comfort is poor. Besides, the soft pad 46 will deform after a period of time to increase discomfort.

The present invention has arisen to mitigate and/or obviate the afore-described disadvantages.

### SUMMARY OF THE INVENTION

The primary object of the present invention is to provide a massage chair for a foot massager that when a user sits on a soft pad, the soft pad is supported by a resilient layer to lower a resilient material of the soft pad and to obtain excellent resilience, softness, and comfort, preventing from deformation and prolonging service life.

To obtain the above objectives, a massage chair for a foot massager contains:

a base including two sliding rails parallel to each other mounted on an upper surface thereof;

a frame including two grooves parallel to each other secured on a lower surface thereof to fit with the two sliding rails of the base, the frame also including two side plates disposed thereon and a resilient layer defined between top surfaces of the two side plates and separated by a plurality of flexible ropes, the resilient layer including a soft pad disposed thereon;

a back support axially coupled with a back side of the frame; and

at least one movable driving device defined between the base and the frame.

### BRIEF DESCRIPTION OF THE DRAWINGS

FIG. 1 is a perspective view showing the assembly of a foot massager according to a first embodiment of present invention;

FIG. 2 is a perspective view showing the exploded components of a massage chair for the foot massager according to the preferred embodiment of present invention;

FIG. 3 is a perspective view showing the assembly of the massage chair for the foot massager according to the preferred embodiment of present invention;

FIG. 4 is another perspective view showing the assembly of the massage chair for the foot massager according to the preferred embodiment of present invention;

FIG. 5 is a plan view showing the assembly of the massage chair for the foot massager according to the preferred embodiment of present invention;

FIG. 6 is a cross sectional view showing the assembly of the massage chair for the foot massager according to the preferred embodiment of present invention;

FIG. 7 is a cross sectional view showing the operation of the massage chair for the foot massager according to the preferred embodiment of present invention;

FIG. 8 is another cross sectional view showing the operation of the massage chair for the foot massager according to the preferred embodiment of present invention;

FIG. 9 is a perspective view showing the assembly of a foot massager according to a second embodiment of present invention;

FIG. 10 is a perspective view showing the assembly of a foot massager according to a third embodiment of present invention;

FIG. 11 is a perspective view showing the assembly of a foot massager according to a fourth embodiment of present invention;

FIG. 12 is a plan view of a conventional foot massager;

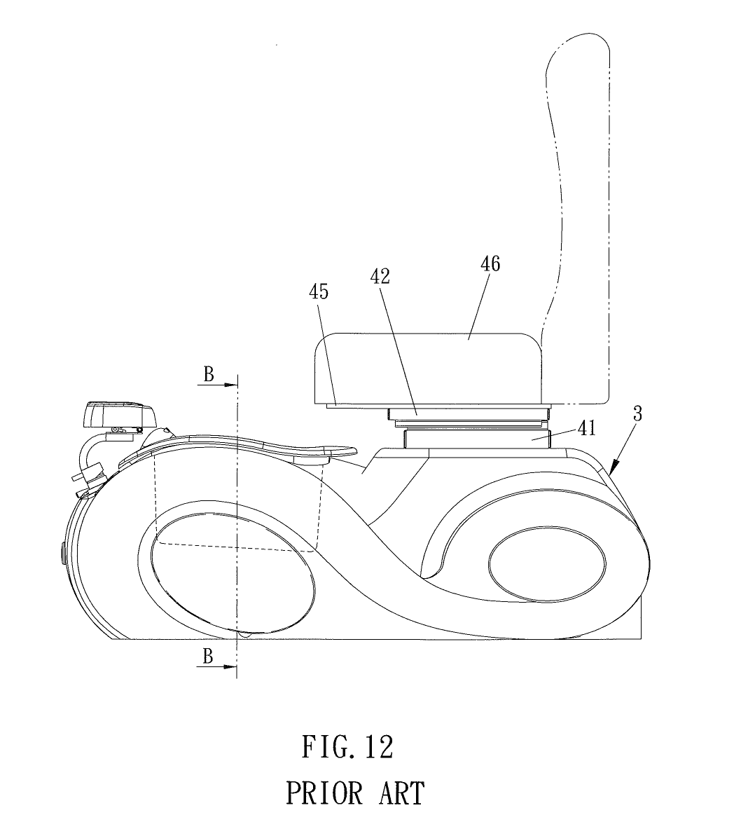

FIG. 13 is a cross sectional view of a conventional foot massager.

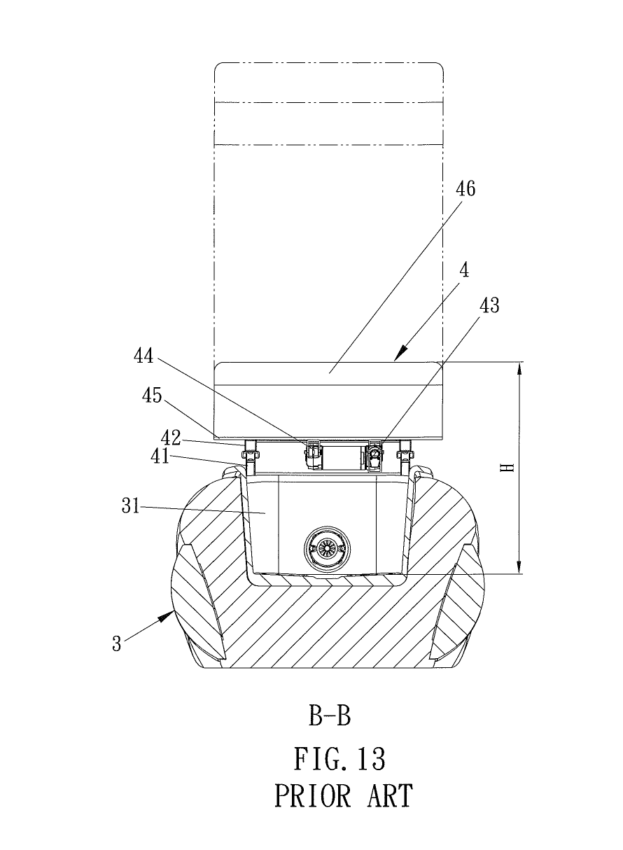

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

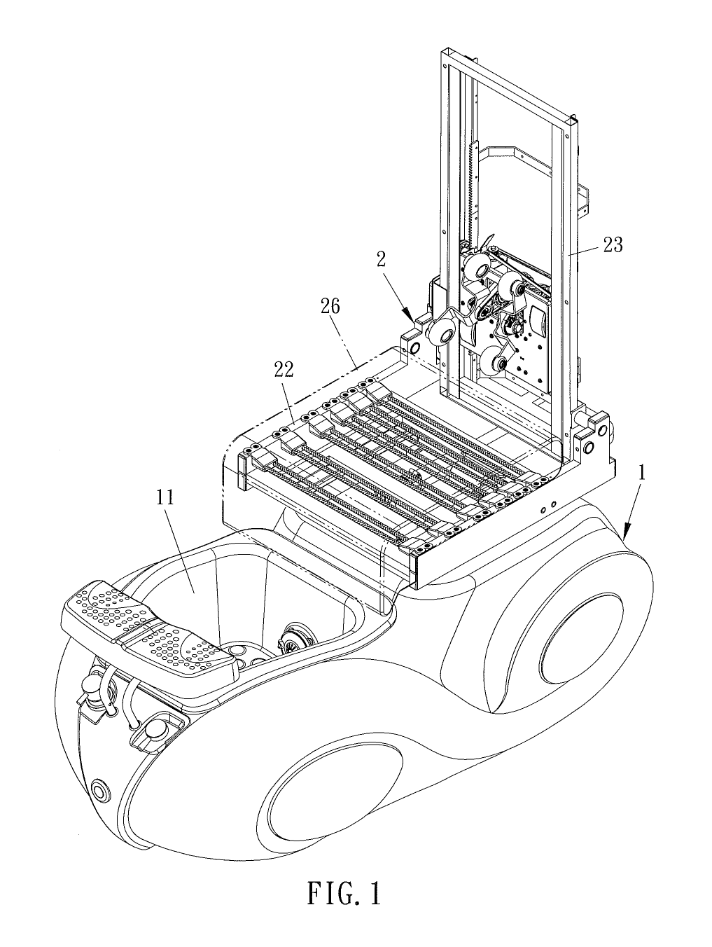

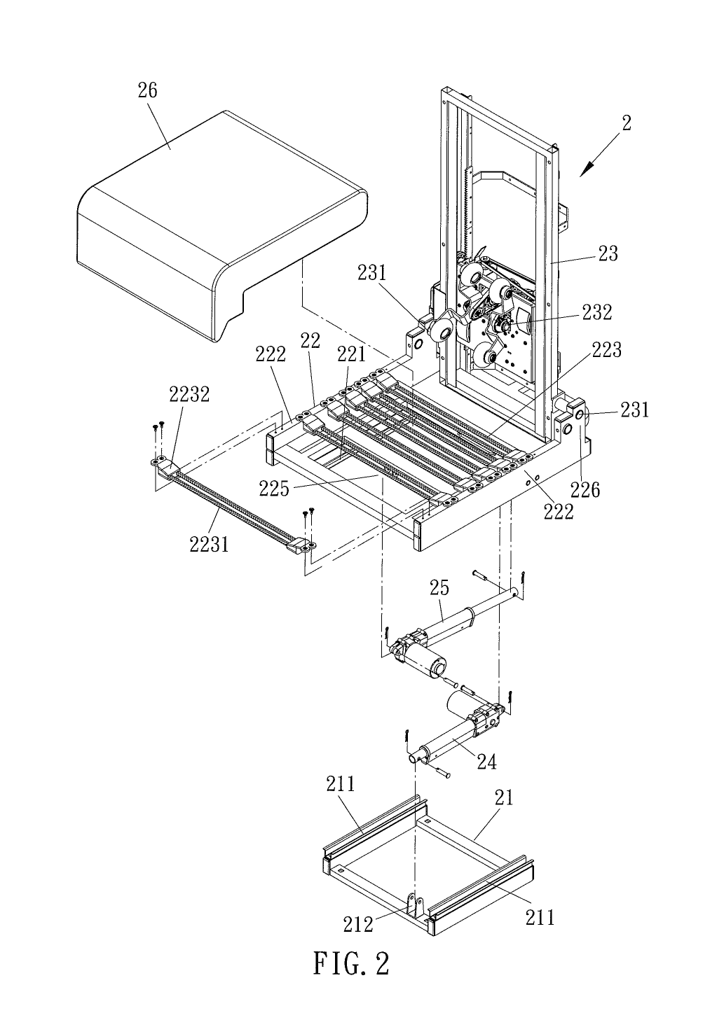

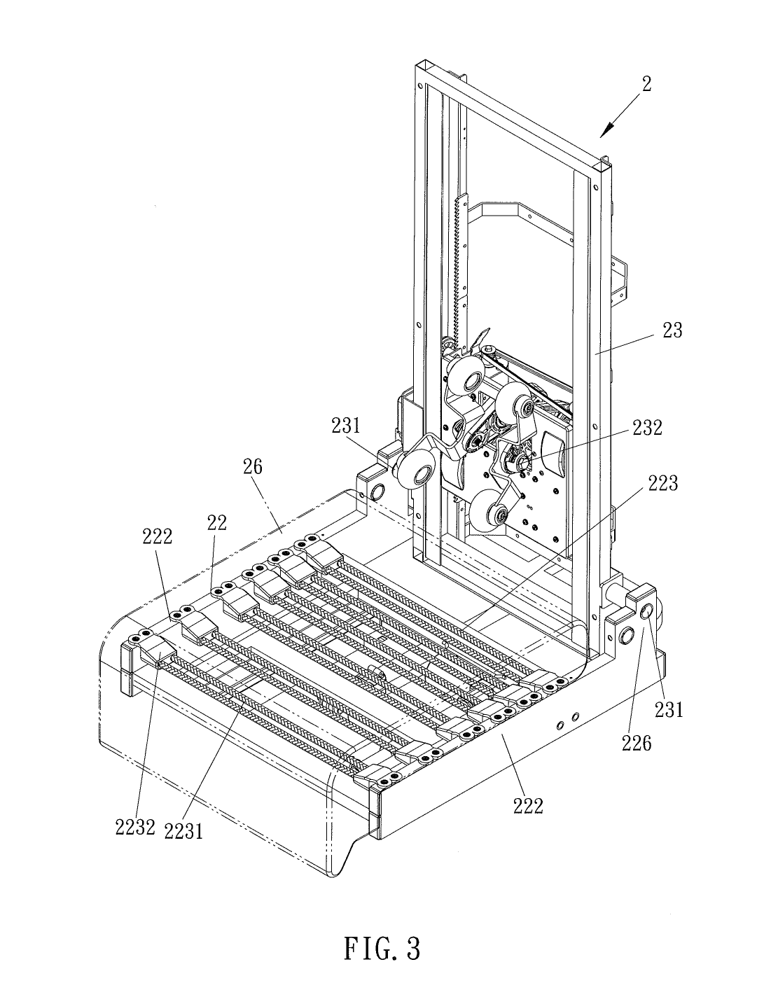

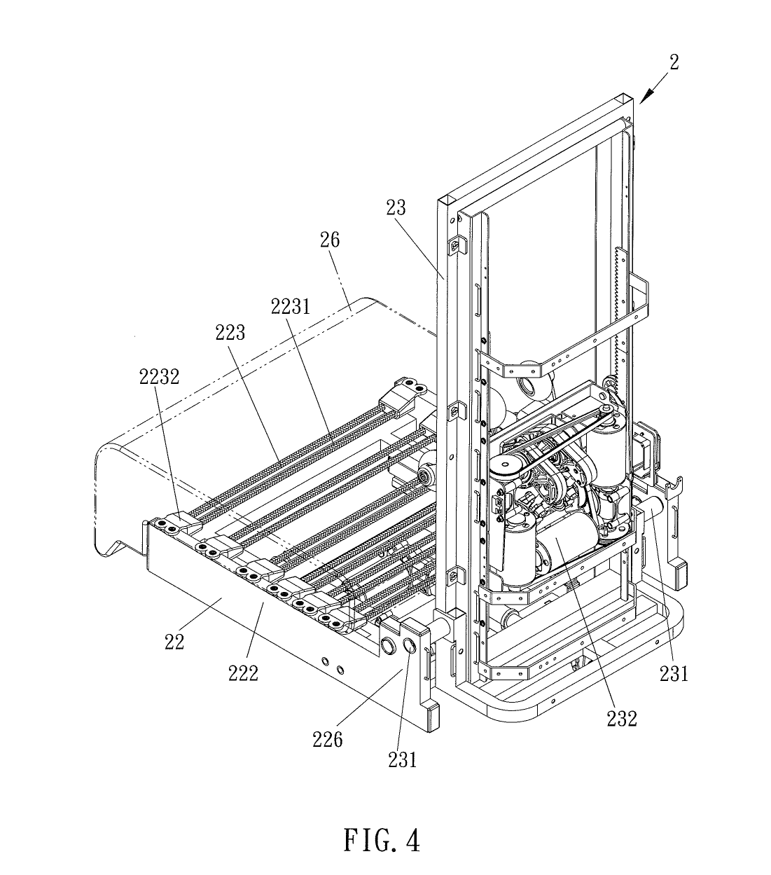

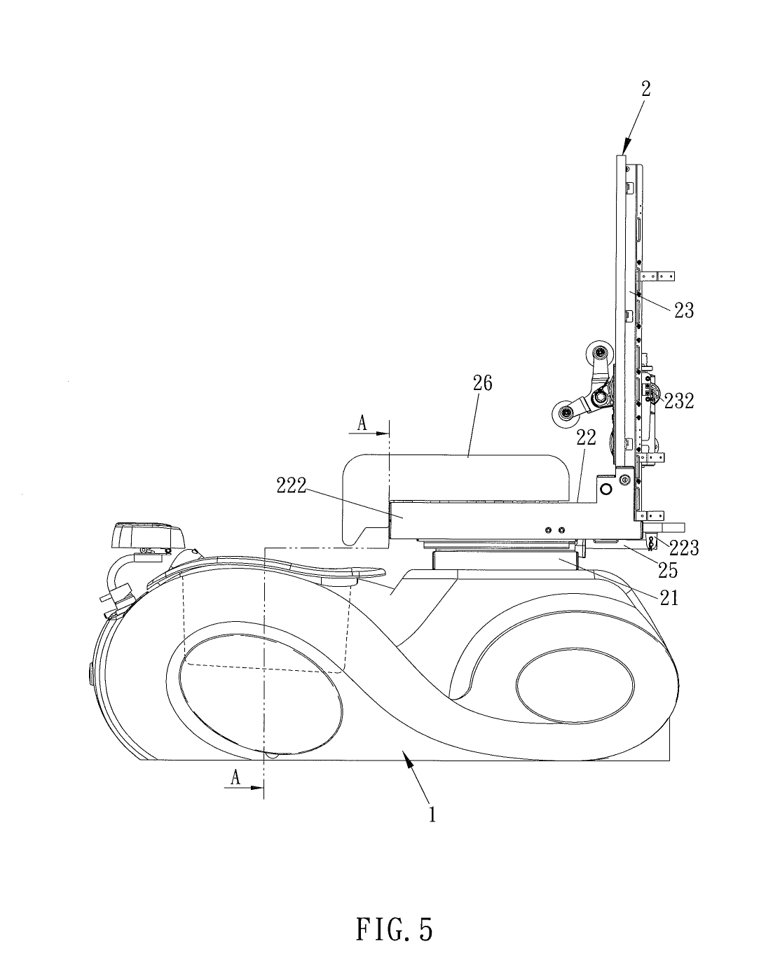

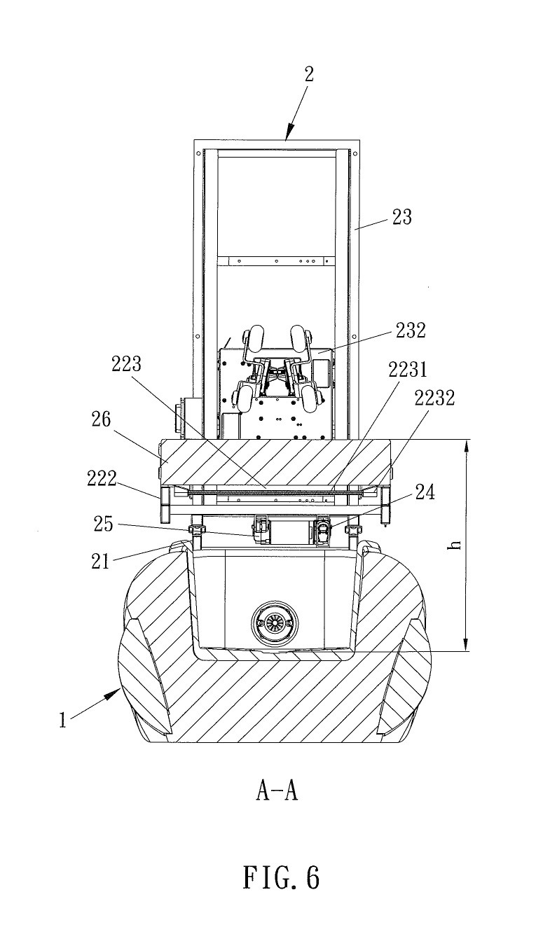

With reference to FIGS. 1-8, a foot massager according to a first embodiment of the present invention comprises: a base 1 connected with a massage chair 2, the base 1 includes a soaking slot 11 disposed on a front side thereof, and the massage chair 2 includes a seat 21, a frame 22, a back support 23, a first movable driving device 24, and a second movable driving device 25, wherein the seat 21 is locked on an upper end of a back side of the base 1 and includes two sliding rails 211 parallel to each other mounted on an upper surface thereof and a first axial connecting unit 212 fixed on a front side thereof. The frame 22 includes two grooves 221 parallel to each other secured on a lower surface thereof to fit with the two sliding rails 211 of the seat 21 so that the frame 22 slides frontward and backward on the seat 21. The frame 22 includes two side plates 222 disposed thereon and a resilient layer 223 defined between top surfaces of the two side plates 222, the resilient layer 223 is comprised of a plurality of flexible ropes 2231, each flexible rope 2231 is fixed between two fixing members 2232 by which the each flexible rope 2231 is fixed between the two side plates 222 as well. The resilient layer 223 includes a soft pad 26 disposed thereon, and the frame 22 includes a second axial connecting unit 224 located at a front side of a lower surface thereof, a third axial connecting unit 225 located at a front side of the lower surface thereof, and two opposite axial holders 226 fixed on a rear side thereof. The back support 23 includes two shafts 231 inserted through two sides thereof individually and the two axial holders 226 of the frame 22 respectively so that the back support 23 is axially coupled with a back side of the frame 22, and the back support 23 includes a vertically movable massage device 232 and a fourth axial connecting unit 233 fixed on a lower end thereof. The first movable driving 24 is defined between the first axial connecting unit 212 of the seat 21 and the second axial connecting unit 224 of the frame 22, the second movable driving device 25 is mounted between the third axial connecting unit 225 of the frame 22 and the fourth axial connecting unit 233 of the back support 23.

The frame 22 includes the resilient layer 223 defined between the top surfaces of the two side plates 222 and comprised of the plurality of flexible ropes 2231, and the resilient layer 223 includes the soft pad 26 disposed thereon, such that the resilient layer 223 is supported by the soft pad 26, and because a thickness of the soft pad 26 is decreased, a height h from a top surface of the soft pad 26 to a bottom surface of the base 1 is equal to a height H of the conventional foot massager.

In operation, hot water is fed into the soaking slot 11 of the base 1 so that a user sits on the massage chair 2 and soaks feet in the soaking slot 11, then the massage device 232 of the back support 23 of the massage chair 2 massages the user.

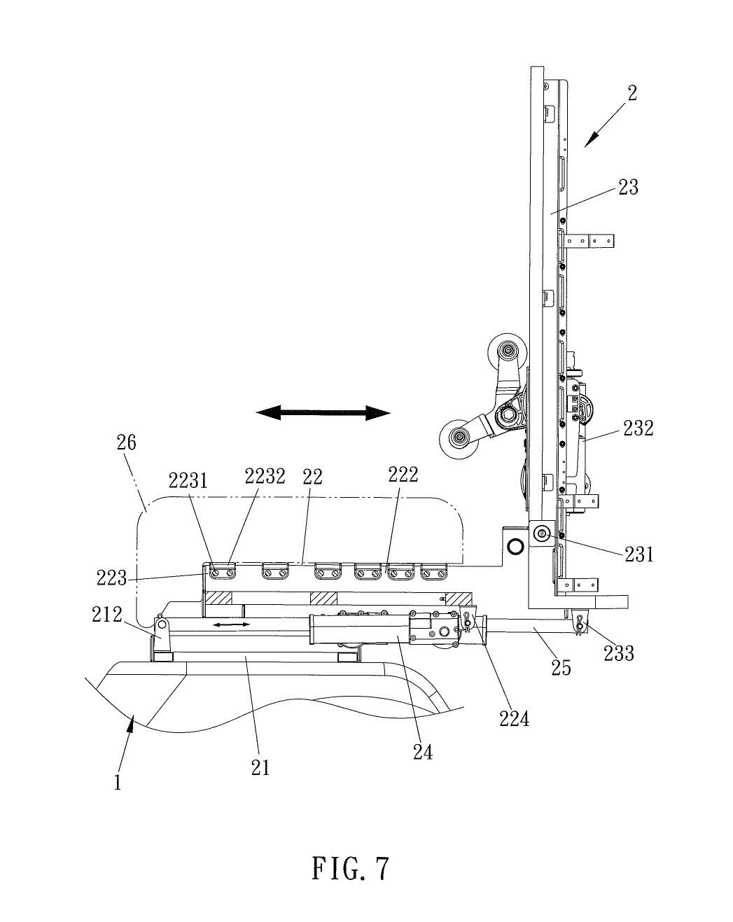

As shown in FIG. 7, the first movable driving device 24 is controlled to expand and retract based on a length of the user's feet, and the frame 22 is actuated to slide frontward or backward, thus adjusting a position of the massage chair 2.

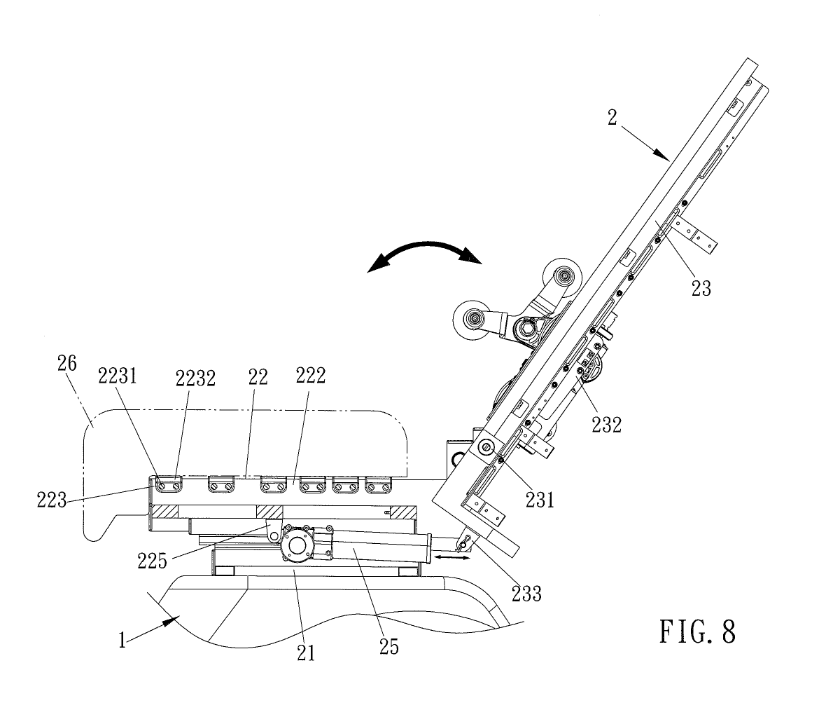

As illustrated in FIG. 8, the second movable driving device 25 is controlled to expand and retract, and the back support 23 is actuated to rotate by using the two shafts 231 as axial centers respectively, thereby adjusting a tilting angle of the back support 23 of the massage chair 2.

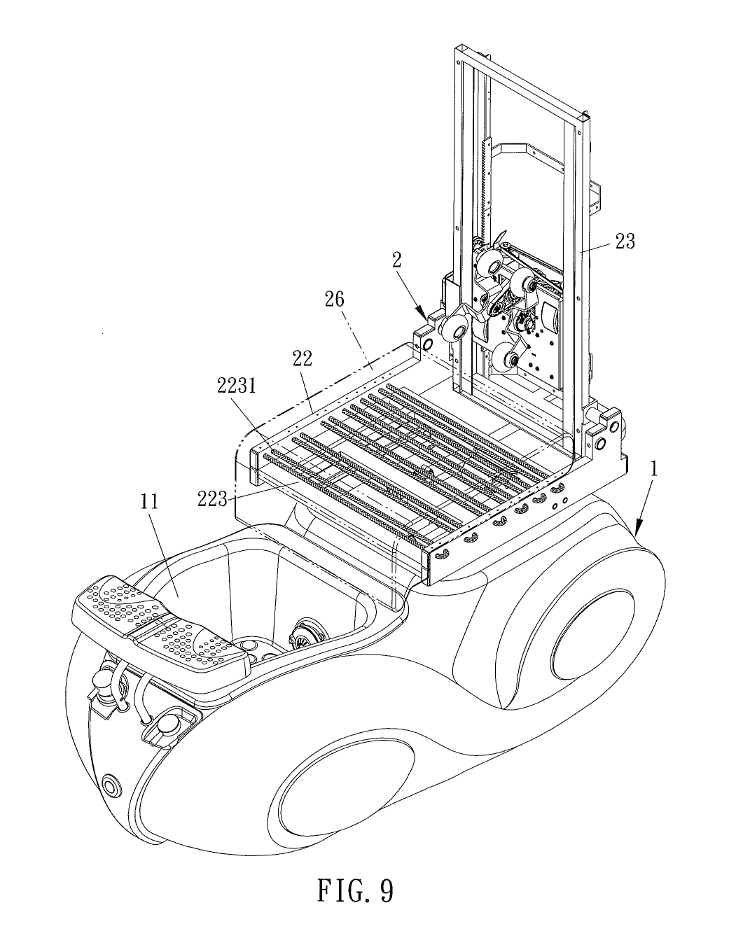

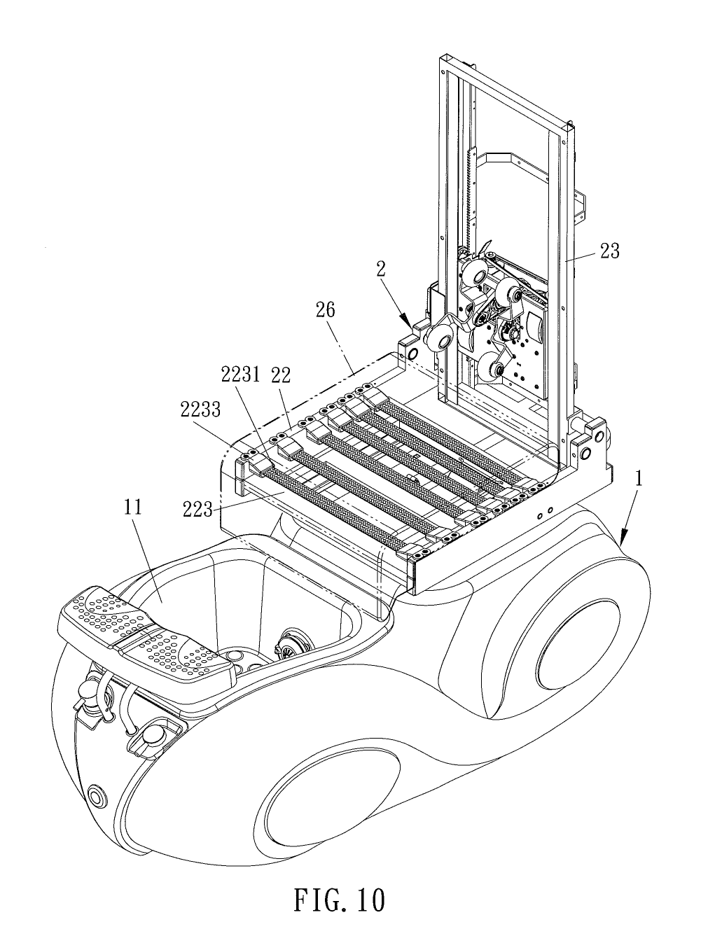

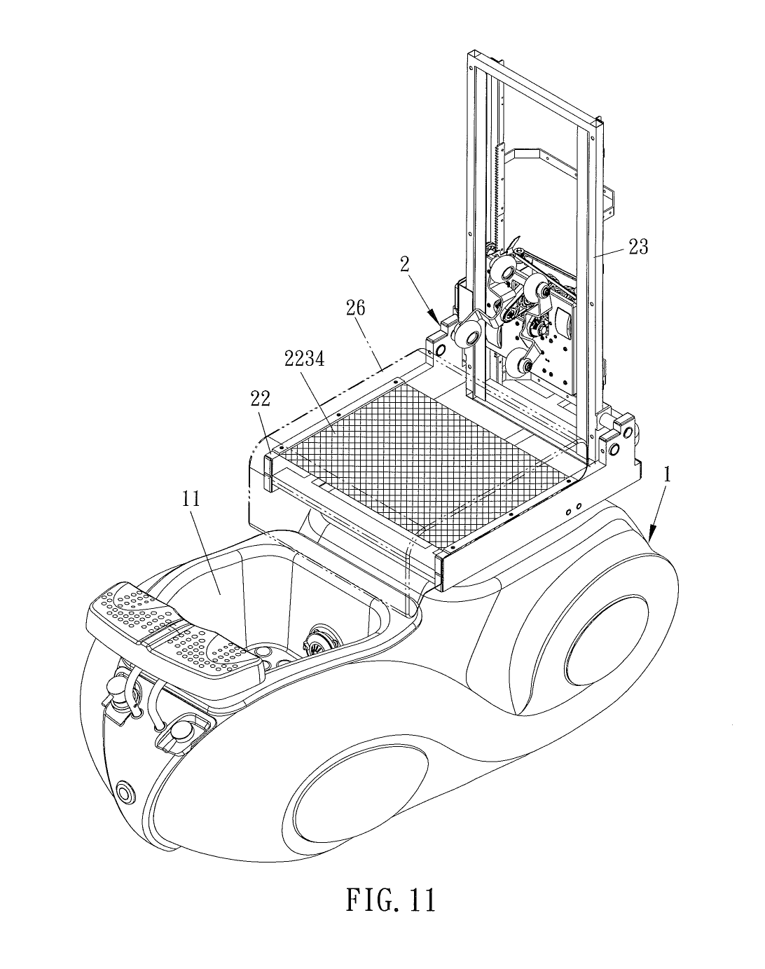

The resilient layer 223 is comprised of the plurality of flexible ropes 2231, and the each flexible rope 2231 is fixed between the two fixing members 2232 by which the each flexible rope 2231 is fixed between the two side plates 222 as well. However, as shown in FIG. 9, a single or a number of flexible ropes 2231 according to a second embodiment of the present invention are inserted through the two side plates 222 of the frame 22. Referring to FIG. 10, the resilient layer 223 of the frame 22 according to a third embodiment of the present invention includes a number of elastic straps 2233 fixed between the fixing members 2232 individually, and each elastic strap 2233 is secured between each two opposite fixing members 2232 so that the each two fixing members 2232 are used to fix each elastic strap 2233 between the two side plates 222. With reference to FIG. 11, the resilient layer 223 of the frame 22 according to a fourth embodiment of the present invention includes a resilient net 2234 arranged on the two side plates 222 of the frame 22.

Thereby, the massage chair 2 of the foot massager includes the resilient layer 223 comprised of the plurality of flexible ropes 2231, the number of elastic straps 2233 or the resilient net 2234, and the resilient layer 223 includes the soft pad 26 disposed thereon so that when the user sits on the soft pad 26, the soft pad 26 is supported by the resilient layer 223 to lower a resilient material of the soft pad 26 and to obtain excellent resilience, softness, and comfort, preventing from deformation and prolonging service life.

While we have shown and described various embodiments in accordance with the present invention, it is clear to those skilled in the art that further embodiments may be made without departing from the scope of the present invention.

What is claimed is:

1. A massage chair for a foot massager comprising
a base including two sliding rails parallel to each other mounted on an upper surface thereof;
a frame including two grooves parallel to each other secured on a lower surface thereof to fit with the two sliding rails of the base, the frame also including two side plates disposed thereon and a resilient layer defined between top surfaces of the two side plates and separated by a plurality of flexible ropes, the resilient layer including a soft pad disposed thereon;
a back support axially coupled with a back side of the frame; and
at least one movable driving device defined between the base and the frame.

2. The massage chair for the foot massager as claimed in claim 1, wherein the resilient layer of the frame is comprised of a plurality of flexible ropes, each flexible rope is fixed between two fixing members by which the each flexible rope is fixed between the two side plates.

3. The massage chair for the foot massager as claimed in claim 1, wherein a single flexible rope is inserted through the two side plates of the frame.

4. The massage chair for the foot massager as claimed in claim 1, wherein a number of flexible ropes are inserted through the two side plates of the frame.

5. The massage chair for the foot massager as claimed in claim 1, wherein the resilient layer of the frame includes a number of elastic straps fixed between the fixing members individually, and each elastic strap is secured between each two opposite fixing members so that the each two fixing members are used to fix each elastic strap between the two side plates.

6. The massage chair for the foot massager as claimed in claim 1, wherein the resilient layer of the frame includes a resilient net arranged on the two side plates of the frame.
